(19) United States
(12) Patent Application Publication
(10) Pub. No.: US 2005/0261930 A1
(43) Pub. Date: Nov. 24, 2005

(54) Method and system for detailed construction estimating

(76) Inventor: Michael W. Litz, Naperville, IL (US)

Correspondence Address: MCANDREWS HELD & MALLOY, LTD, 500 WEST MADISON STREET, SUITE 3400, CHICAGO, IL, 60661, US

(21) Appl. No.: 11/108,372

(22) Filed: Apr. 18, 2005

Related U.S. Application Data
(63) Continuation-in-part of application No. PCT/US03/32452, filed on Oct. 14, 2003.
(60) Provisional application No. 60/419,461, filed on Oct. 17, 2002.

(51) Int. Cl. G06F 17/60

(52) U.S. Cl. 705/1

(57) ABSTRACT

A method and system for construction estimating facilitates the estimation of construction activities, including at least one of metal stud framing, wallboard construction, ceiling suspension, acoustical ceiling tile construction and related insulation systems,. The method includes the steps of: (a) compiling construction activity data in a database, (b) categorizing the data in the database according to construction related parameters, and (c) employing a database analysis and reporting system to construction estimating. The present method and system provide a comprehensive and organized construction-estimating database for construction estimating professionals, construction service business owners, and for suppliers of general contractors, construction managers, construction developers and architects.

### CROSS-REFERENCE TO RELATED APPLICATION(S)

This application is a continuation-in-part of International Application No. PCT/US03/32452, having an international filing date of Oct. 14, 2003, entitled “Method and System for Detailed Construction Estimating”. International Application No. PCT/US03/32452 claimed priority benefits, in turn, from U.S. Provisional Patent Application No. 60/419,461 filed Oct. 17, 2002. International Application No. PCT/US03/32452 is also hereby incorporated by reference herein in its entirety.

### FIELD OF THE INVENTION

The present invention is directed to a method and system for facilitating the estimation of metal stud framing systems, wallboard systems, ceiling suspension systems, acoustical ceiling tile systems, and related insulation systems in support of professional estimators of said systems through the use of software for building construction estimating, but also adaptable to road, bridge and tunnel construction estimating, manufacturing and product assembly process estimating.

### BACKGROUND OF THE INVENTION

The present system and method offer a new way for construction takeoffs and estimates to be conducted. Although databases are currently offered with construction estimating software, these offerings are highly inadequate and inefficient. Not only are the databases incomplete, but they also contain predominantly incorrect information and are disorganized.

These inefficiencies and inadequacies result from the lack of knowledge and capabilities among the software producers, the data organizers and the end users (construction estimators) during the data building and organizing process. This lack of synergistic knowledge, or “information gap”, is exacerbated by the unwillingness and/or inability of many construction estimators to effectively share their knowledge accumulated throughout years of experience. Accordingly, no software producer has built an advanced database system for use by estimators of the aforementioned trades.

The databases currently offered with construction-specific estimating software are inadequate in scope relative to the number of items (data sets) included in the database. The software manufacturers indicate that the data is not meant to be complete. Software manufacturers contend that the end users should utilize the data provided as a sample. Software manufacturers contend that estimators should customize each of their individual databases to suit each estimator's personal requirements. Perhaps in the past, considering the evolution of computer hardware and software, it was prudent to be more selective with entries in such a database. However, given the recent progress in hardware and software capabilities, a database of the requisite size does not present a problem. While it is true that each estimator's data requirements vary, access to a comprehensive database would not in any way inhibit an estimator's job performance if the data is well organized. Realistically, immediate access to a comprehensive database could only enhance any estimator's job performance.

The databases currently offered with construction-specific estimating software contain predominantly incorrect information within the minutiae of the data. Software manufacturers again contend that the end users should use the data provided as a sample; they again contend that estimators should customize each of their individual databases to suit each estimator's personal requirements. Confusion most likely lies in misconceptions regarding the data's purpose within a given database.

The are several misconceptions about construction estimating techniques:

Misconception No. 1:
Fact: Estimates are performed in various geographical locations, and actual construction costs do vary according to the location.
Misconception: Specific information relative to a given item in a database would be applicable to estimates for one location, yet, irrelevant to estimates for other locations.

Misconception No. 2:
Fact: Types of construction projects vary dramatically in size and function, moreover, the level of complexity relative to each individual construction project can vary dramatically; actual construction costs do vary according to these factors.
Misconception: Specific information relative to a given item in a database would be applicable to estimates for one type of project, yet, irrelevant to estimates for other types of projects.

Misconception No. 3:
Fact: Variations are limitless relative to the combination of the numerous construction elements comprising an architectural detail.
Misconception: Specific information relative to a given item in a database would be applicable to estimates for particular aspects of an architectural detail, yet, irrelevant to estimates for other aspects of the same architectural detail or other different architectural details.

Multiple variables do exist among the requirements of individual estimators; however, a single, unambiguous database could be compatible with the requirements of end users. The present method and system accomplishes this by compiling consistent, comprehensive, and accurate data; furthermore, this database has been organized in a logical and consistent method.

The databases currently offered with construction-specific estimating software contain disorganized data. The data within the minutiae of the individual data sets is disorganized. Potential interactions between data entries, both within and among the data sets, are undeveloped.

A need thus exists to better bridge the information gaps among the software producers, the data organizers, and the end users (construction estimators) during the data building and organizing process.

### SUMMARY OF THE INVENTION

A method for construction estimating facilitates the estimation of construction activities including at least one of metal stud framing, wallboard construction, ceiling suspension, acoustical ceiling tile construction and related insulation systems. The method comprises the steps of:
(a) compiling construction activity data in a database;
(b) categorizing the data in the database according to construction related parameters;
(c) employing a database analysis and reporting system to construction estimating.

In a preferred method embodiment, the data includes area and perimeter measurements such that ratios can be employed to calculate labor production rates.

In another preferred method embodiment, the data is organized such that each of the data sets contains at least one of construction material data and construction labor data. Each of the data sets preferably contains construction labor data organized such that each of the labor data sets represents at least one of labor alone and labor with automation. Each of the data sets more preferably contains construction labor data organized such that each of the labor data sets represents labor with automation and each of the labor-with-automation data sets links other related data sets to form logical assemblies.

In another preferred method embodiment, the data sets are categorized into the three categories of construction material, construction labor and construction labor-with-automation.

A construction estimating system facilitates the estimation of construction activities including at least one of metal stud framing, wallboard construction, ceiling suspension, acoustical ceiling tile construction and related insulation systems. The system comprises:
(a) a database comprising construction activity data;
(b) a routine for categorizing the data in the database according to construction related parameters;
(c) a database analysis and reporting function.

In a preferred system embodiment, the data includes area and perimeter measurements for calculating ratios employable to calculate labor production rates.

In another preferred system embodiment, the data comprises data sets comprising at least one of construction material data and construction labor data. Each of the data sets preferably contains construction labor data organized such that each of the labor data sets represents at least one of labor alone and labor with automation. Each of the data sets more preferably contains construction labor data organized such that each of the labor data sets represents labor with automation and each of the labor-with-automation data sets links other related data sets to form logical assemblies.

In another preferred system embodiment, the data sets are categorized into the three categories of construction material, construction labor and construction labor-with-automation.

### BRIEF DESCRIPTION OF THE DRAWINGS

FIG. 1 is a flowchart enumerating the eight essential stages of the professional takeoff and estimating process according to the present method and system.

FIG. 2a is a flowchart of the architectural detail component identification process, (relative to a commercial ceiling-height partition) according to the present method and system.

FIG. 2b is a flowchart of the architectural detail component identification process (relative to an acoustic ceiling system) according to the present method and system.

FIG. 3a is a synopsis of the metal stud framing systems portion of the database according to the present method and system.

FIG. 3b is a synopsis of the wallboard systems portion of the database according to the present method and system.

FIG. 3c is a synopsis of the insulation systems portion of the database according to the present method and system.

FIG. 3d is a synopsis of the ceiling suspension systems portion of the database according to the present method and system.

FIG. 3e is a synopsis of the acoustic ceiling tile systems portion of the database according to the present method and system.

### DETAILED DESCRIPTION OF PREFERRED EMBODIMENT(S)

The present method and system utilizes software designed and manufactured specifically for construction estimating to facilitate the estimation of metal stud framing systems, wallboard systems, ceiling suspension systems, acoustical ceiling tile systems, and related insulation systems in support of professional estimators of said systems. Although the present system and method can be used in connection with other applications, for the purposes of illustration, limited examples are used throughout the specification.

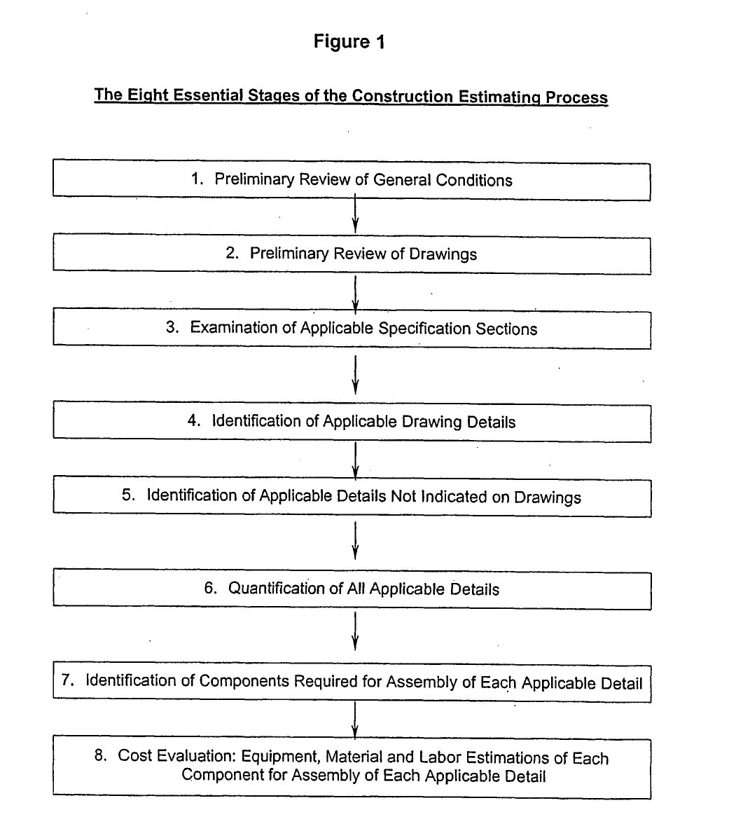

FIG. 1 shows a broad overview of the eight essential stages of the construction takeoff and cost estimation process. Stages one through six, the processes comprising the takeoff, are actually prerequisites to the estimation process. The present method and system facilitates both speed and accuracy especially during the vital seventh stage. The efficiently categorized automated data sets significantly expedite the seventh stage processes. The comprehensive extent of the database associated with the present method and system enables the end user to select automated data sets, accurately reflecting any given assembly of labor and material components. The tedious eighth stage of the construction cost estimation process is thereby effectively eliminated.

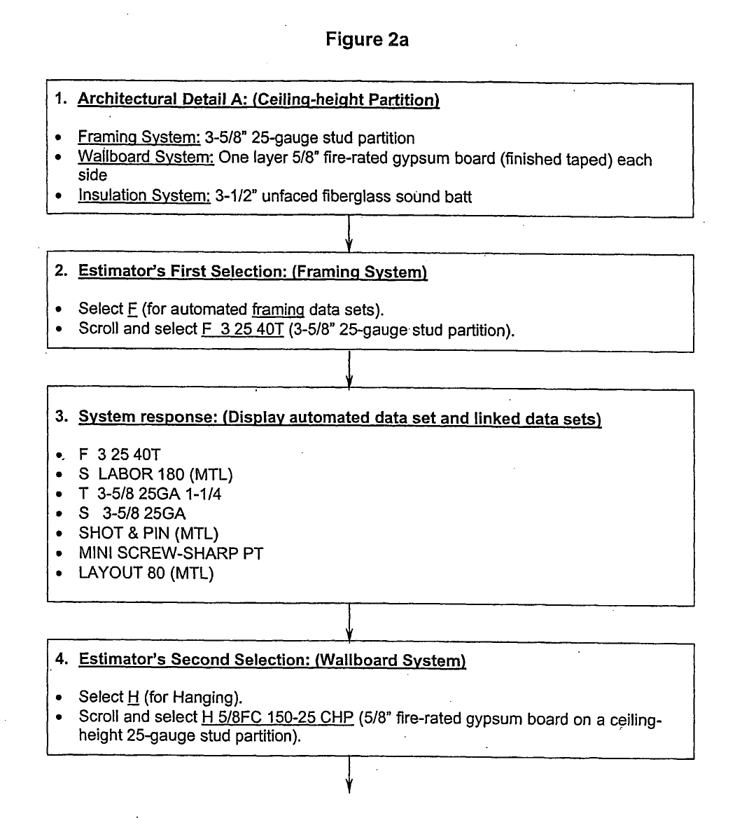

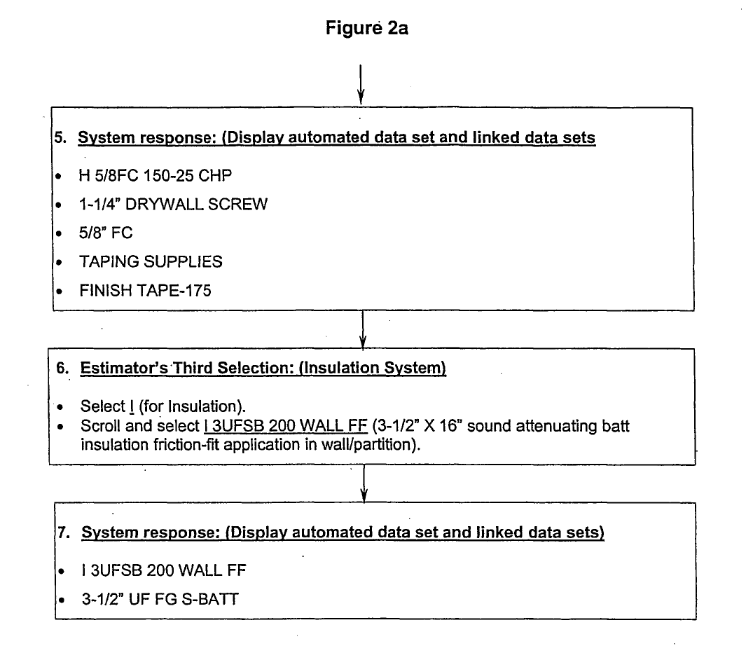

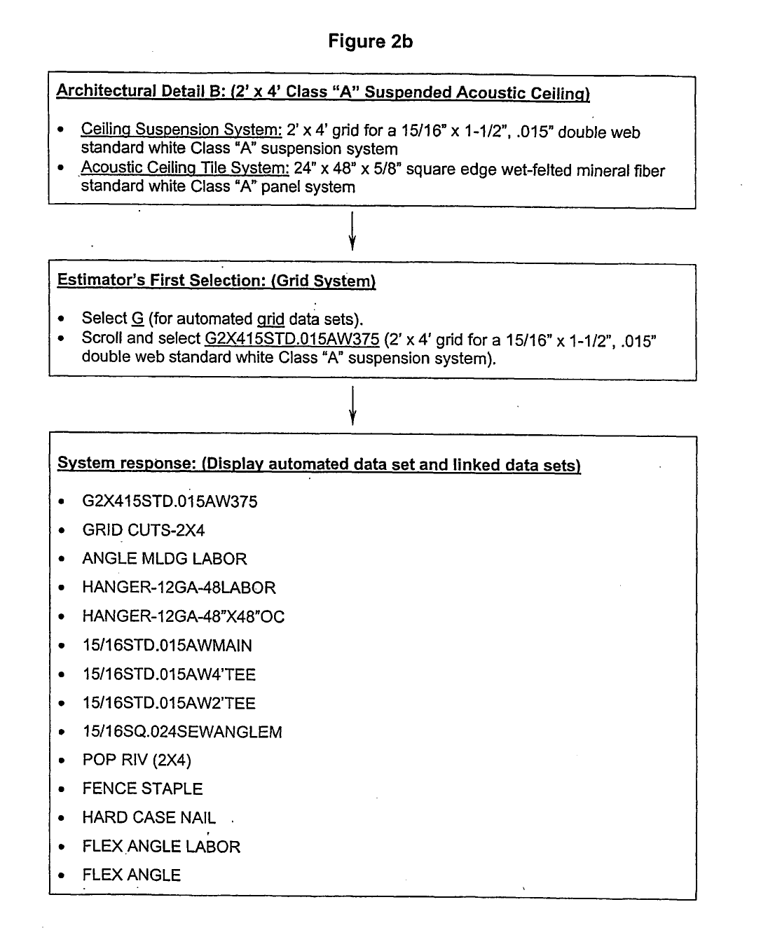

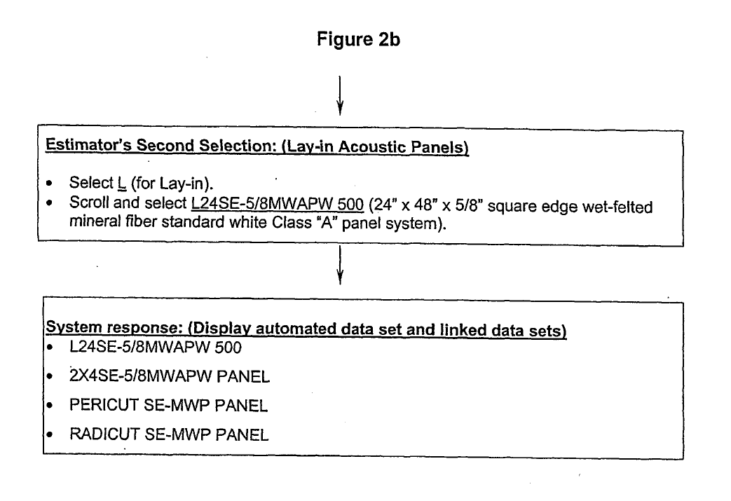

FIGS. 2a and 2b illustrate a preferred embodiment of the present method and system from the perspective of the seventh essential stage (as enumerated in FIG. 1) of the professional estimating process. Referring to FIG. 2a, an estimator has identified the components of “Architectural Detail A” in square 1. In Square 2, the estimator selects the desired framing system. Square 3 indicates the systems response to the estimator's first selection. In Square 4, the estimator selects the appropriate wallboard system. Square 5 indicates the systems response to the estimator's second selection. In Square 6, the estimator selects the appropriate insulation system. Square 7 indicates the systems response to the estimator's third selection. The estimator would proceed to select casing bead, sound sealant, and any other appropriate selections, simulating “Architectural Detail A”. This assembly would then be complete; previously named selections would not require any adjustment.

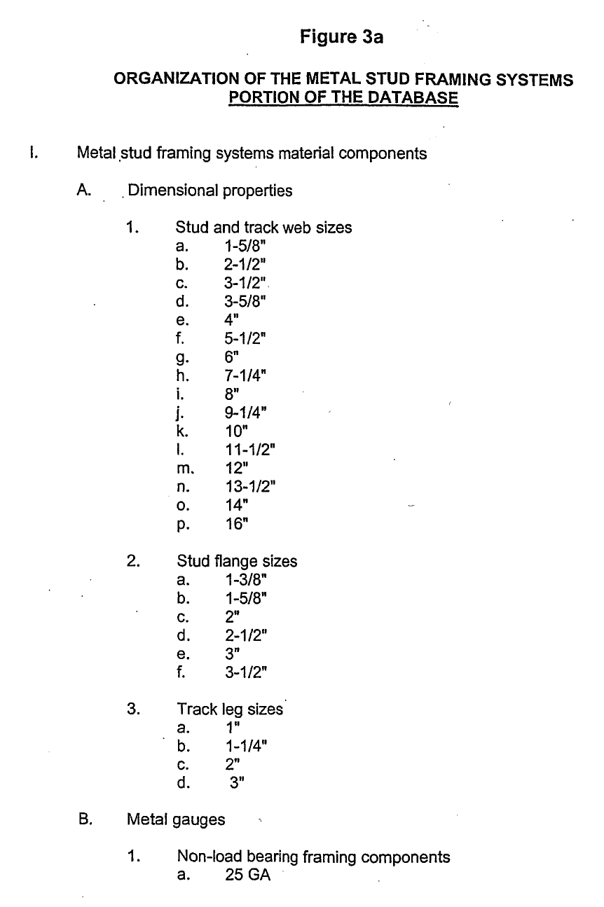

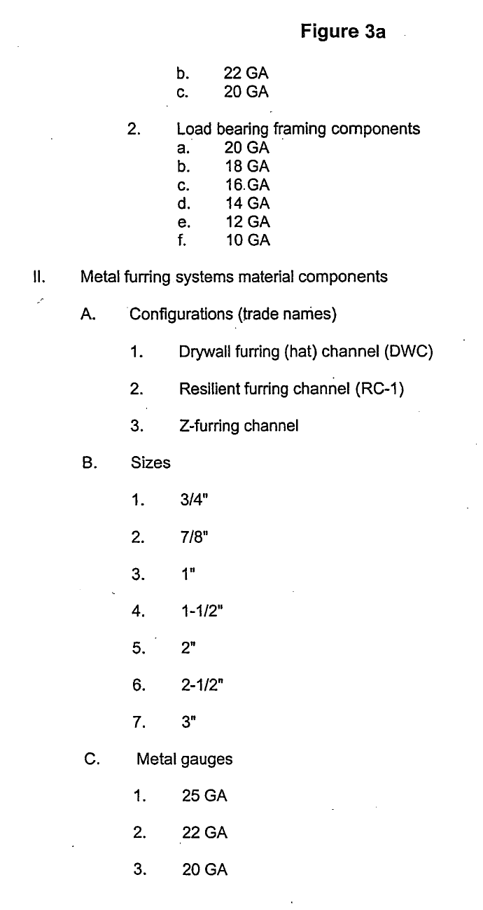

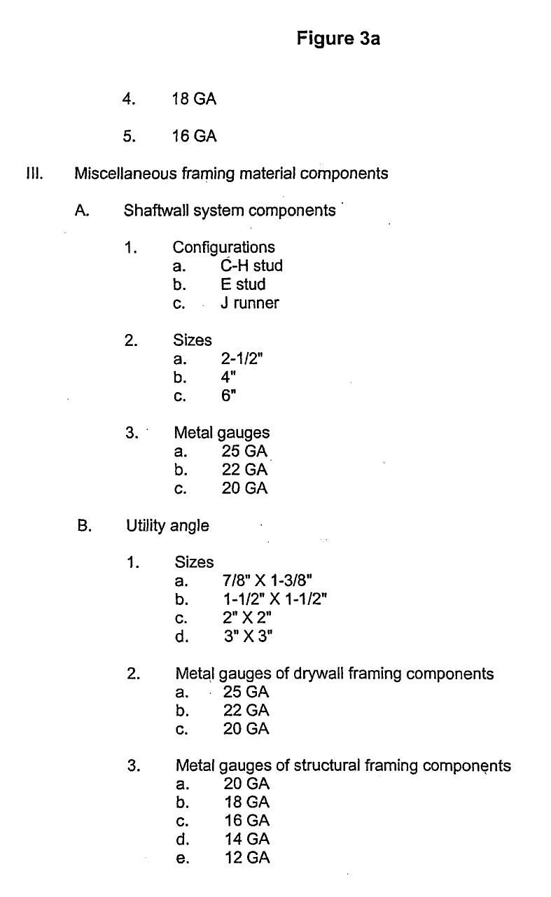

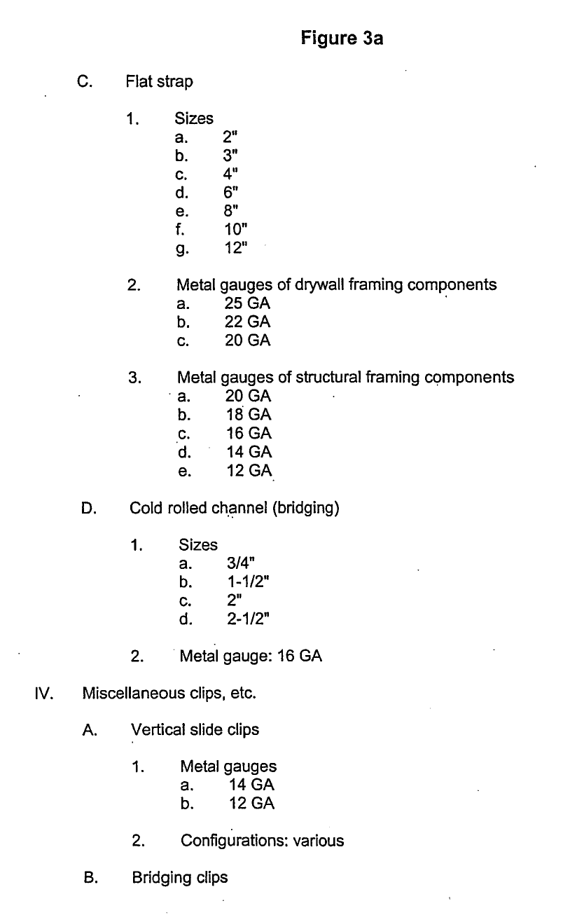

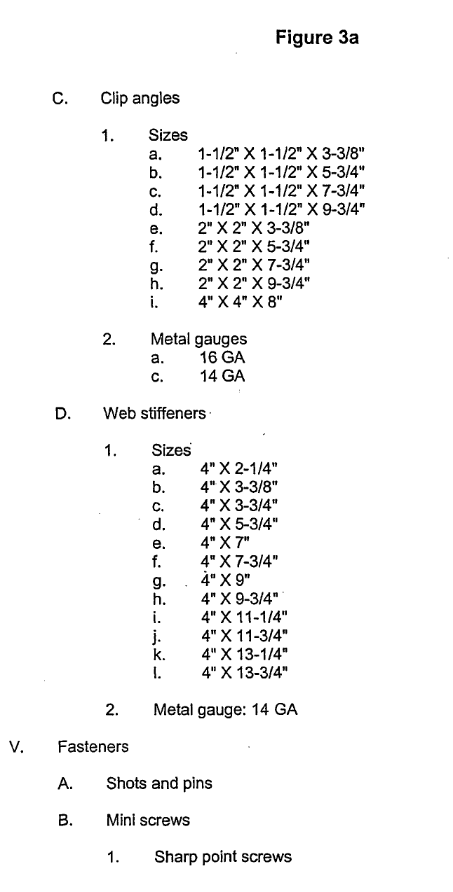

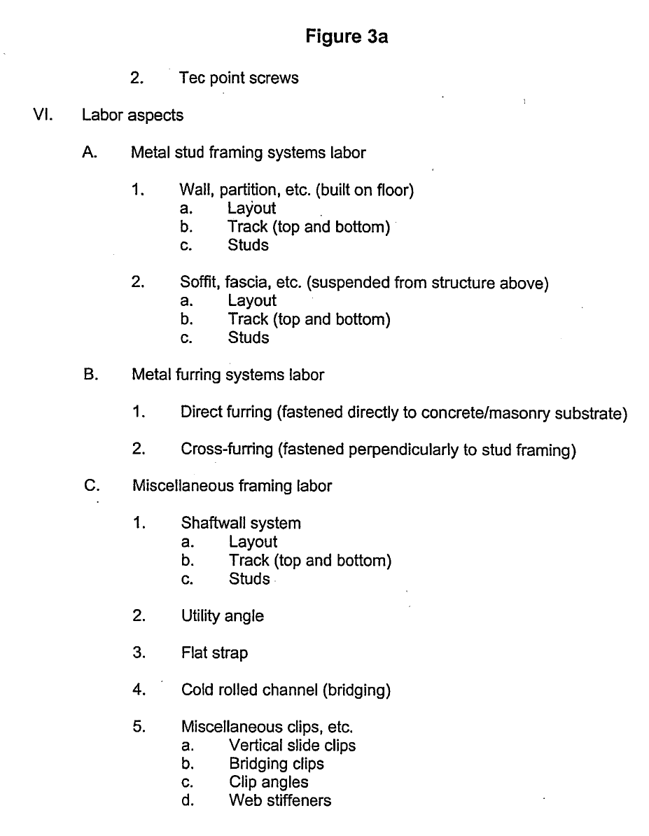

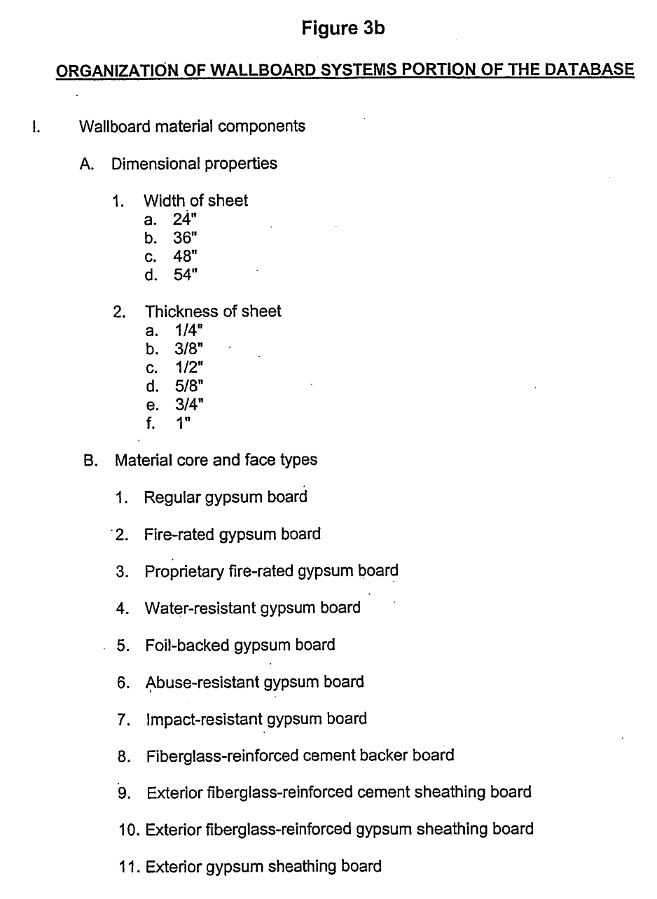

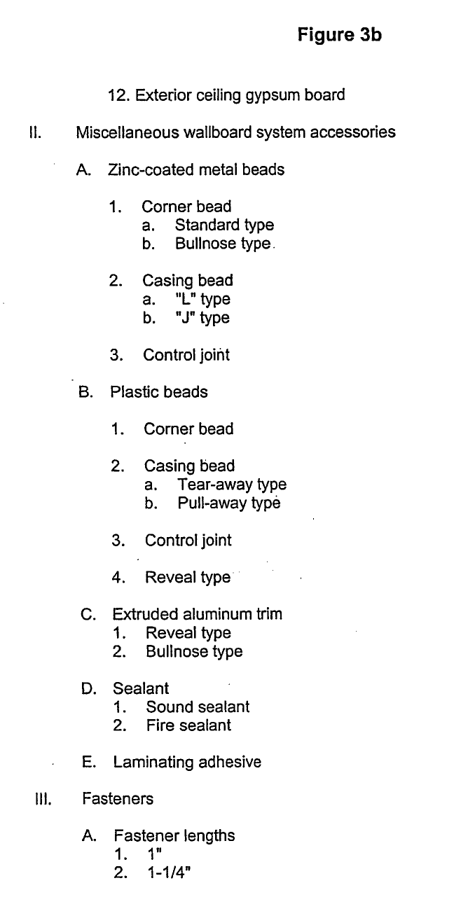

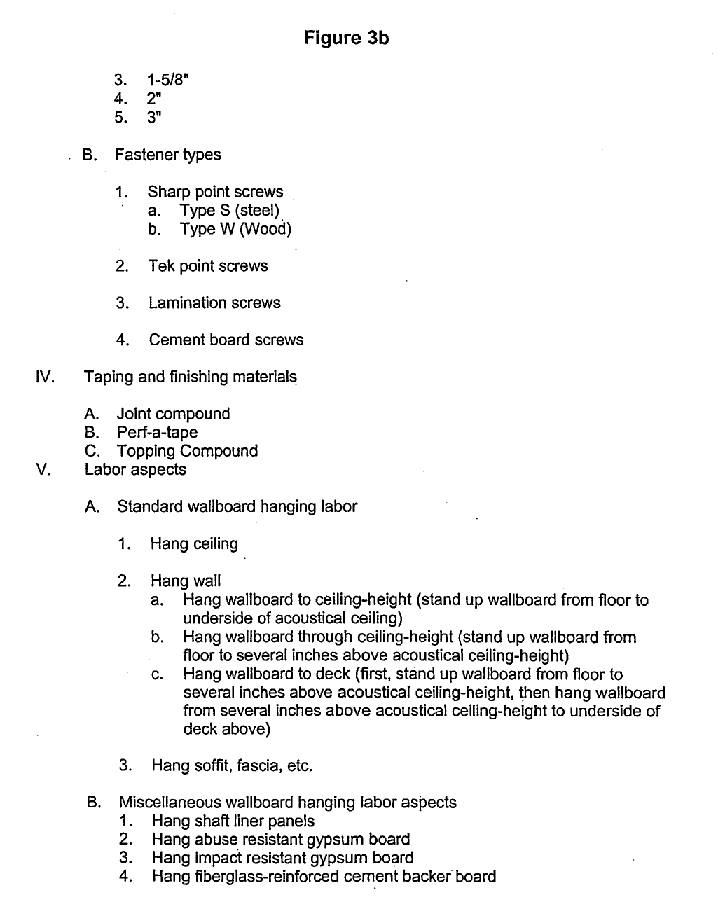

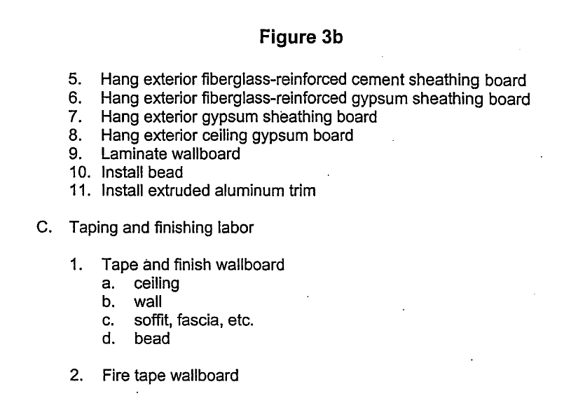

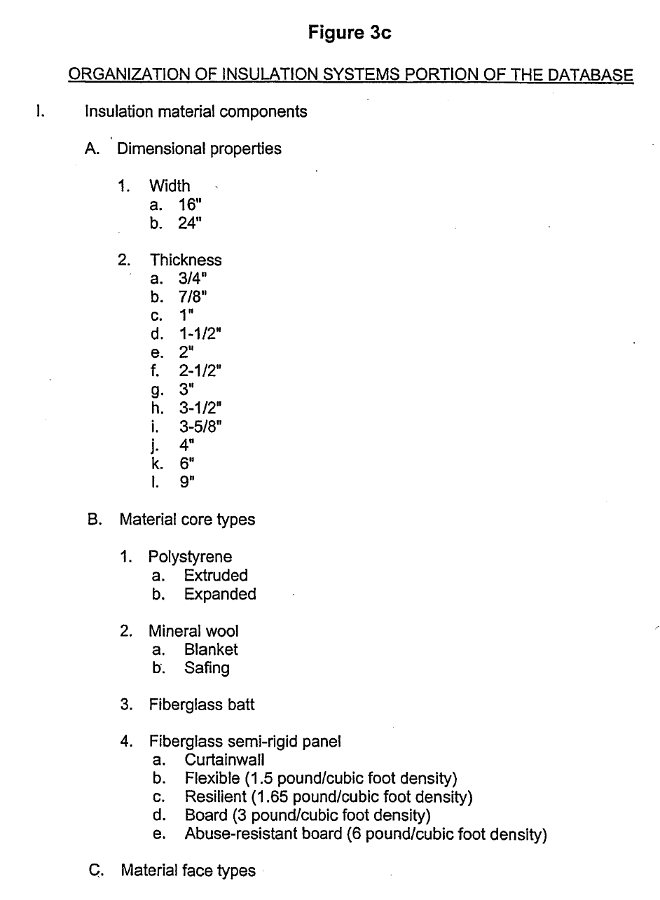

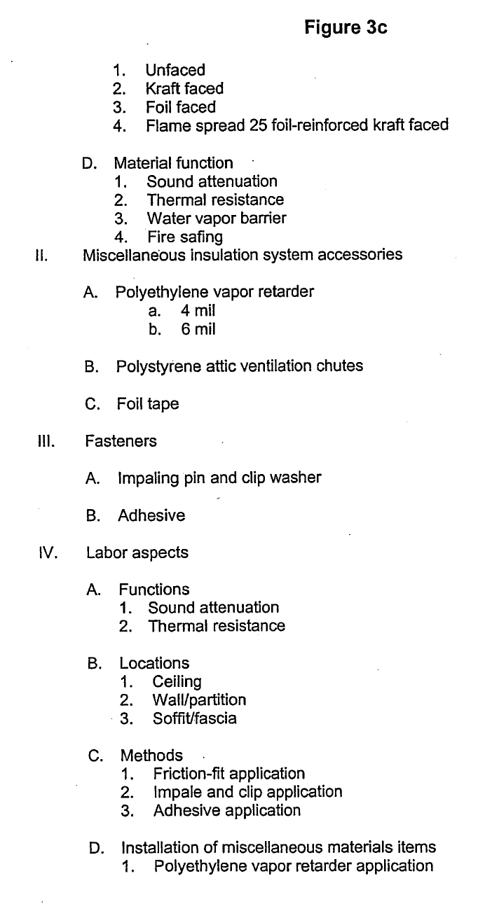

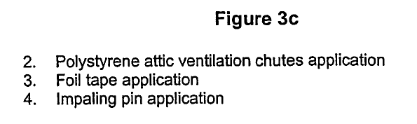

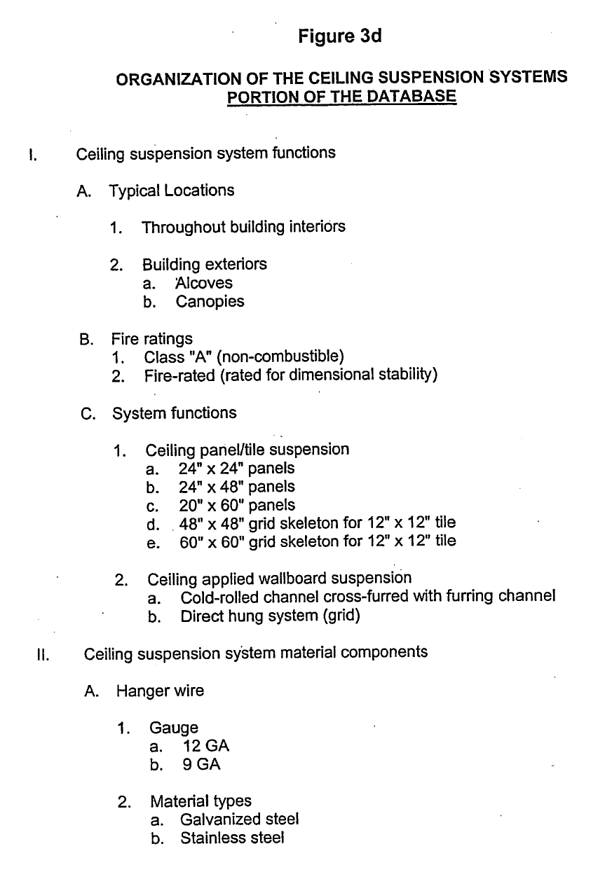

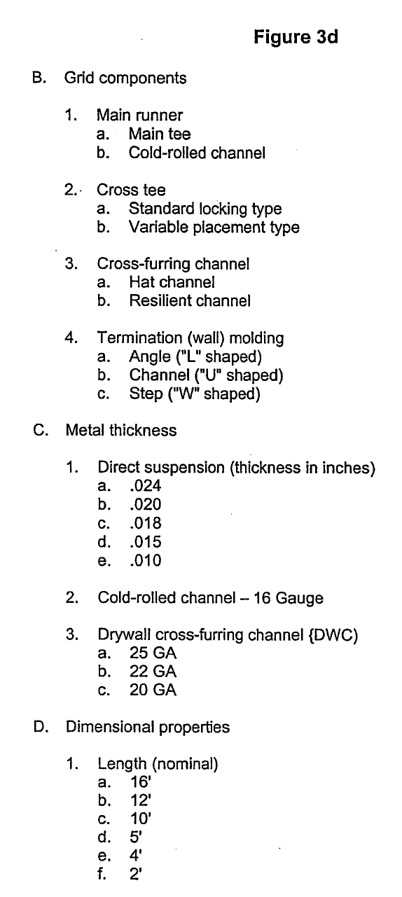

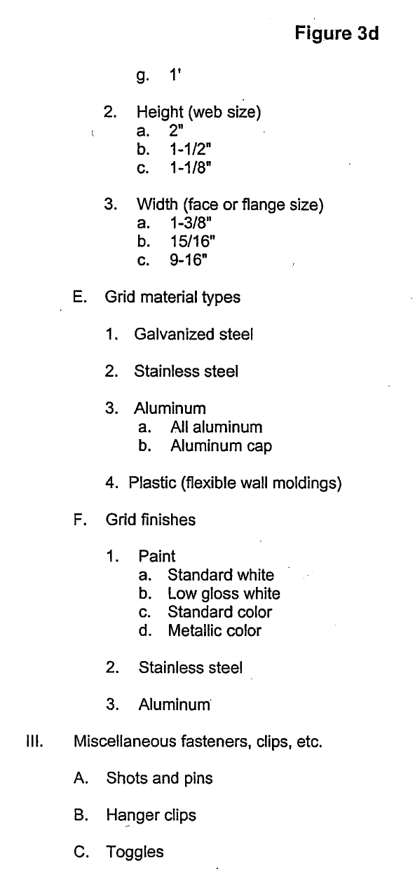

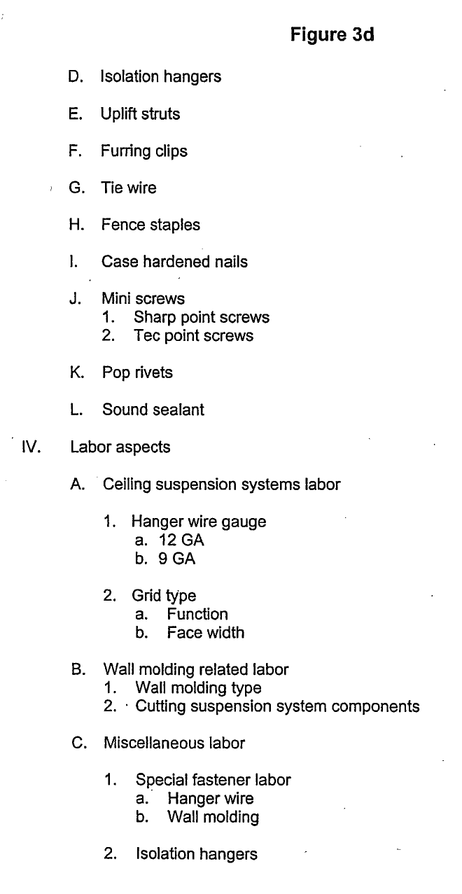

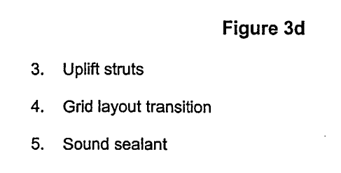

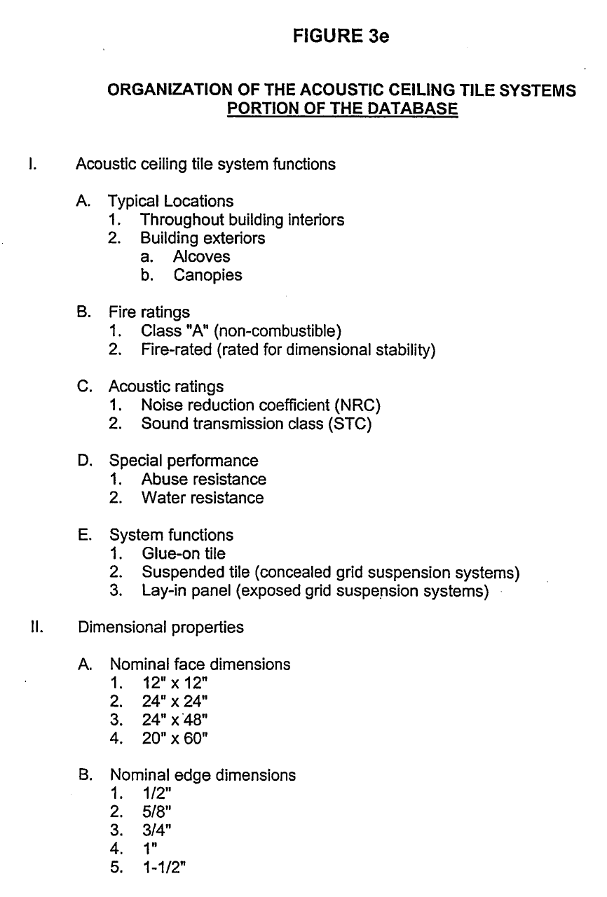

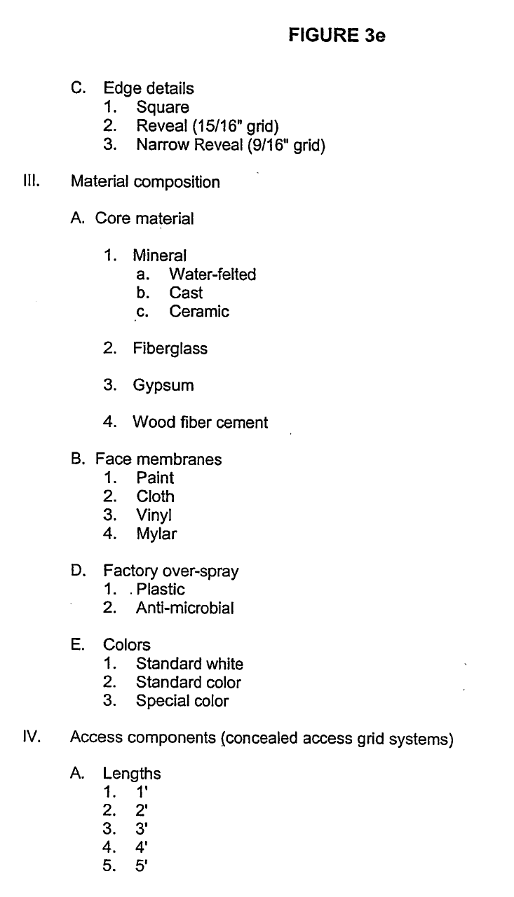

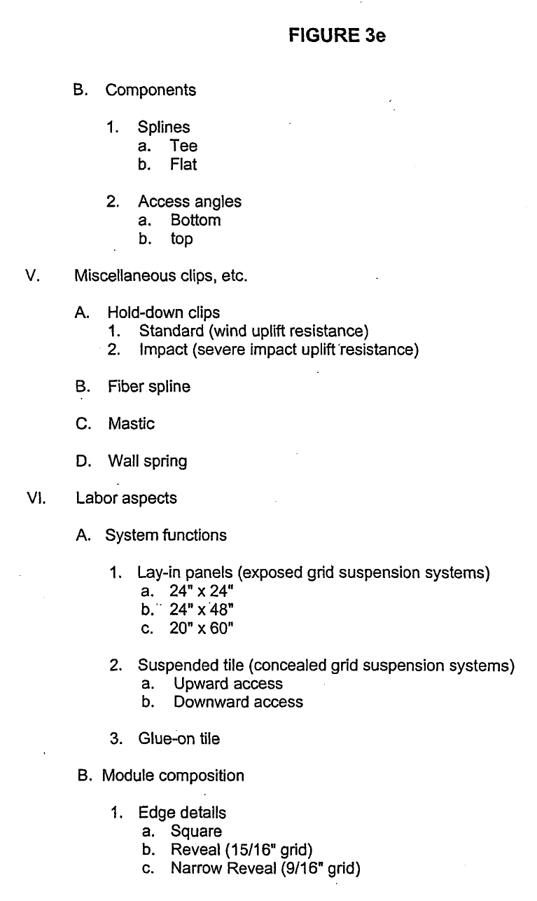

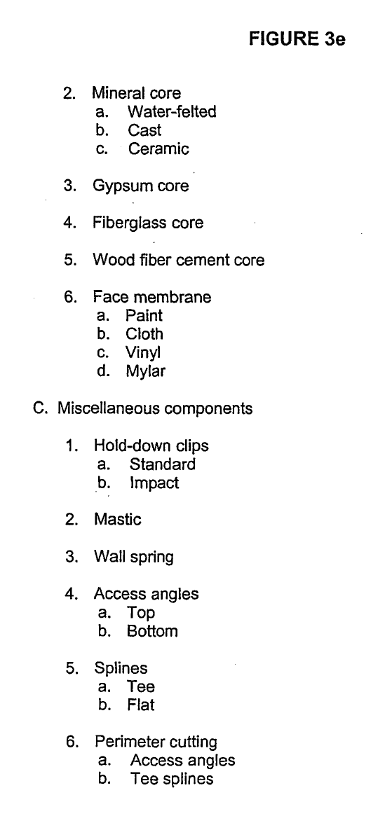

Referring to FIGS. 3a-e, the organization of each system's portion of the database is accomplished in four essential steps as follows:
The first step is to identify the appropriate material data sets. Each distinct material item (within the limitation of industry-standard material production) requires one similarly distinct data set. Each of these data sets is classified as material only; with few exceptions, no labor analysis is included within any of these data sets. Exceptions to the separation of material data sets from labor data sets are limited to those material components with a singular labor aspect. Separating such items would add superfluous data sets to the database and thus be counterproductive.
The second step is to identify the appropriate labor data sets. Each distinct labor application (within the limitation of reasonable parameters) requires one similarly distinct data set. Each of these data sets is classified as labor only; no material is included within any of these data sets.
The third step is to logically organize the minutiae within each of the data sets. Continuity is the key to this endeavor. Typically, software systems designed specifically for construction estimating contain multi-tabbed data entry records to accommodate the information to characterize each data set. Considerable thought should accompany each data entry. Continuity commences by accumulating desired information, in conjunction with maintaining the minimum variation among data sets within the database. Likewise, categorizing the data sets' names, or codes, while maintaining a logical pattern, and minimizing variation among the codes, accomplishes continuity.
The fourth and final step to organize the database is to link the data sets together into logical patterns facilitating automation for the end-user (professional construction estimator). This step is actually accomplished concurrently with the aforementioned, third step. However, this final step produces new data sets that interact with other data sets already produced in the third step. These labor-oriented, automated data sets are named for the specific assembly of components represented by the automated data set, linked labor data sets, and linked material data sets. Each assembly of components (within the limitation of reasonable parameters) requires one similarly distinct automated data set.

The number of labor data sets might seem limitless to some professional estimators in this field of work. However, fortunately, this is not the case. The present method and system is a thorough collection of the labor data sets to estimate the most complex architectural details. The production rates were derived by means of thoughtful preparation in conjunction with decades of experiencing professional estimating, observation, and cost analysis.

Referring to FIGS. 3a-c, the following is clarification of the phrase, “within the limitation of reasonable parameters” (with reference to labor and automated data sets). The present method and system includes a distinct data set representing each distinct material item (within the limitation of industry-standard material production). However, the inclusion of matching labor data sets for each material item is superfluous for the following reasons:
(1) Referring specifically to FIG. 3a, the labor attributes associated with stud material of the same web size and gauge, but various flange sizes, are relatively indistinct. Likewise, the labor attributes associated with track material of the same web size and gauge, but various leg sizes, are relatively indistinct.
(2) The present method and system's database assimilates stud and track assemblies via two distinct automated data sets (refer to FIG. 3a, VI.A.1. and VI.A.2.) for each combination of gauge and web size (within the limitation of industry-standard material production). At first perception, the categorization of only two general distinctions between automated labor data sets might seem to be overly simplistic. After all, metal stud framing systems are utilized in myriad configurations. However, fundamentally, these are the only two essential distinctions. The most commonly utilized stud flange size is 1⅝″ and track leg size is 1¼″; items with these dimensions are the default selections in the automated data sets.
(3) Referring specifically to FIG. 3b, the labor attributes associated with various wallboard products of similar size, weight and composition are relatively indistinct.
(4) The database associated with the present method and system assimilates wallboard assemblies via several distinct automated data sets (refer to FIG. 3b, outline heading V.). The most commonly utilized wallboard types are the default selections in the automated data sets.
(5) Referring specifically to FIG. 3c, the labor attributes associated with various insulation products of similar size, density, and composition are relatively indistinct.
(6) The database associated with the present method and system assimilates insulation assemblies via several distinct automated data sets (refer to FIG. 3c, outline heading IV.). The most commonly utilized insulation types are the default selections in the automated data sets.

Referring to FIGS. 3a-c, the addition of distinct labor data sets identifying relatively redundant labor attributes would clutter the database and add confusion for the end user. Furthermore, the additional labor data sets would require correlated automated data sets; this would also clutter the database and add confusion for the end user. Inevitably, the added clutter and confusion would be counterproductive.

Nevertheless, when sizes other than the default selections are desired, the end user can accommodate this condition as follows:
After selecting the most closely related automated data set to the desired assembly, the end user can then substitute the appropriate material data sets, thereby refining the assembly to the exact requirements of any given architectural detail.

Referring to FIGS. 3d and 3e, the following is a clarification of the phrase “within the limitation of reasonable parameters” (with reference to material, labor, and automated data sets). The present method and system includes a distinct data set representing each distinct labor item and generic material item (within the limitation of reasonable parameters). However, specialized data sets for specific paint colors are categorized rather than segregated for the following reasons:
(1) The material pricing aspect within each selected paint color category does not vary. Likewise, the labor aspect within each selected paint color category does not vary.
(2) The addition of distinct material data sets identifying these relatively redundant specific paint colors attributes would clutter the database and add confusion for the end user. Furthermore, the additional material data sets would require correlated automated data sets; this would also clutter the database and add confusion for the end user. Inevitably, the added clutter and confusion would be counterproductive.
(3) The database associated with the present method and system assimilates suspension system assemblies via a distinct automated data set for each (within the limitation of industry-standard material production) combination of (refer to FIG. 3d) fire rating (I.B.), system function (I.C.), metal thickness (II.C.), face width (II.D.3.), material type (II.E.), and paint finish (II.F.1.).

(4) The database associated with the present method and system assimilates acoustic ceiling tile system assemblies via a distinct automated data set for each (within the limitation of industry-standard material production) combination of (refer to FIG. 3e) fire rating (I.B.), system function (I.E.), dimensional properties (II.), material composition (III.), access components (IV.), and miscellaneous clips, etc. (V.).

At first perception, a single distinct automated labor data set representing each of the above combinations of attributes might seem to be overly simplistic. After all, actual labor production rates for ceiling suspension systems and acoustic ceiling tile systems vary significantly. However, these significant rate variations within each distinct type of ceiling system are fundamentally bound to one simple ratio, the ratio of area to perimeter. Therefore, only data sets related to area are calculated relative to area quantities; data sets related to perimeter are calculated relative to perimeter quantities. The area labor production rate varies according to the ratio of area to perimeter; thus, the present invention automatically calculates precise labor production rates for ceiling suspension systems and acoustic ceiling tile systems. The logical organization of the minutiae within each of the data sets incorporates default settings for these calculations.

Nevertheless, occasionally data sets other than the default selections are appropriate; the end user can accommodate this situation as follows:
After selecting the most closely related automated data set to the appropriate assembly, the end user can then substitute or add the appropriate labor and/or material data sets, thereby refining the assembly to the exact requirements of any given ceiling system.

The present method and system promotes efficiency for the end user via logical default settings in the automated data sets. Thus, a relatively compact database comprises a thorough collection of data sets to expediently estimate the most complex architectural details.

In addition, the extensive generic database of the present method and system allows the end user limitless potential to customize generic assemblies to reflect favorite specific brand names.. This customization can be accomplished via the following two basic methods:
(1) End users can simply rename selected data sets to reflect favorite specific brand names.
(2) End users can duplicate and rename selected data sets to reflect favorite specific brand names.

The advantage to the latter method is the option to create multiple brand names for each generic data set. The former method's virtue is maintaining the compact size of the database.

Referring to FIG. 3a, the first step is to identify the appropriate material data sets. A frequently utilized data set, 3⅝″ 25-gauge stud, corresponds to the following combination of attributes as described in the outline:
I.A.1.d. (3⅝″ web)
I.A.2.b. (1⅝″ flange)
I.B.1.a. (25 Gauge)

Another commonly utilized data set, 3⅝″ 25-gauge (1 1/4″ leg) track, similarly corresponds to the following combination of attributes:
I.A.1.d. (3⅝″ web)
I.A.3.b. (1¼″ leg)
I.B.1.a. (25 Gauge)
   Once again, each distinct material item requires one similarly distinct data set.

The second step is to identify the appropriate labor data sets. A frequently utilized data set, 3⅝″ 25-gauge partition stud labor, corresponds to the following combination of attributes as described in the subject outline:
I.A.1.d. (3⅝″ web)
I.A.2.b. (1⅝″ flange)
I.B.1.a. (25 Gauge)
VI.A.1.c. (partition stud labor)

Another commonly utilized data set, 3⅝″ 25-gauge soffit/fascia stud labor, similarly corresponds to the following combination of attributes:
I.A.1.d. (3⅝″ web)
I.A.2.b. (1⅝″ flange)
I.B.1.a. (25 Gauge)
VI.A.2.c. (soffit/fascia studlabor)
   Once again, each distinct labor item requires one similarly distinct data set.

The third step is to logically organize the minutiae within each of the data sets. Once again, the familiar data set, 3⅝″ 25-gauge stud, corresponds to the following combination of attributes as described in FIG. 3a:
I.A.1.d. (3⅝″ web)
I.A.2.b. (1⅝″ flange)
I.B.1.a. (25 Gauge)

Another commonly utilized data set, 3⅝″ 20-gauge stud, similarly corresponds to the following combination of attributes:
I.A.1.d. (3⅝″ web)
I.A.2.b. (1⅝″ flange)
I.B.1.a. (25 Gauge)

Hence, the only informational variation contained in the multi-tabbed data entry records for these two data sets relates to the metal gauge, because the metal gauge is the only distinguishing characteristic between the two data sets. Likewise, the “5” in the former data set and the “0” in the latter data set are the only distinguishing characters in the data sets' names, or codes. The following are the respective codes for the two aforementioned data sets:
S 3⅝ 25GA
S 3⅝ 20GA
   The codes name the data sets clearly and precisely.

The fourth and final step to organize the database is to connect the data sets into logical patterns facilitating automation for the end-user. A frequently utilized automated data set, framing material and labor for a 3⅝ 25-gauge stud partition, corresponds to the following combination of attributes as described in FIG. 3a:
I.A.1.d. (3⅝″ web)
I.A.2.b. (1⅝″ stud flange)
I.A.3.b. (1¼″ track leg)
I.B.1.a. (25 Gauge)
V.A. (Shots and pins)
V.B.1. (Sharp point mini screws)
VI.A.1. (Metal stud partition framing labor aspects)

The following data sets represent this (framing material and labor for a 3⅝ 25-gauge stud partition) assembly:
Labor: Layout (wall, partition, etc.)
Material: 3⅝″ 25-gauge track with 1¼″ leg
Material: Shots and pins
Labor: 3⅝″ 25-gauge track (wall, partition, etc.)
Material: 3⅝″ 25-gauge stud
Material: Sharp point mini screws
Labor: 3⅝″ 25-gauge stud (wall, partition, etc.)

The automated data set for this (framing material and labor for a 3⅝″ 25-gauge stud partition) assembly should be distinguishable from other similar data sets. However, five of the seven data sets for this assembly are common to other automated data sets. Therefore, the logical selection for this automated data set is the first distinct data set listed above, the labor for 3⅝″ 25-gauge track. Some software systems (designed specifically for construction estimating) limit codes for naming data sets to a relatively small number of characters. Therefore, the present method and system employs the following code to name this (framing material and labor for a 3⅝″ 25-gauge stud partition) automated data set:
F 3 25 40T

This code is decoded as follows:
F=Framing material and labor
3=3⅝″
25=25 gauge
40T=Track labor production rate of 40 linear feet of track per hour

Thus (refer to FIG. 2a), when the following condition is appropriate:
Framing material and labor for a 3⅝″ 25-gauge stud partition

The following automated data set is selected:
F3 25 40T

Then, the following data sets will appear automatically:
F 3 25 40T
S LABOR 180 (MTL)
T 3⅝ 25GA 1¼
S 3⅝ 25GA
SHOT AND PIN (MTL)
MINI SCREW-SHARP PT
LAYOUT 80 (MTL)

These codes are decoded as follows (the “(MTL)” portion of each code distinguishes data sets related to metal stud framing from data sets related to structural steel stud framing):
F 3 25 40T=Framing material and labor for a 3⅝ 25-gauge stud partition with track labor production rate of 40 linear feet of track per hour
S LABOR 180 (MTL)=Stud labor production rate of 180 linear feet of stud per hour
T 3⅝ 25GA 1¼=Material (track as described)
S 3⅝ 25GA=Material (stud as described)
SHOT AND PIN (MTL)=Material (as described)
MINI SCREW-SHARP PT=Material (as described)
LAYOUT 80 (MTL)=Layout labor production rate of 80 linear feet per hour

Another common automated data set is framing material and labor for a 3⅝″ 25-gauge stud soffit/fascia. Similarly to the previous example, when the following condition is appropriate:
Framing material and labor for a 3⅝″ 25-gauge stud soffit/fascia

The following automated data set is selected:
F 3 25 20T

Then, the following data sets will appear automatically:
F 3 25 20T
S LABOR 90 (MTL)
T 3⅝ 25GA 1¼
S 3⅝ 25GA
SHOT AND PIN (MTL)
MINI SCREW-SHARP PT
LAYOUT 40 (MTL)

These codes are decoded as follows:
F 3 25 20T=Framing material and labor for a 3⅝″ 25-gauge stud partition with track labor production rate of 20 linear feet of track per hour
S LABOR 90 (MTL)=Stud labor production rate of 90 linear feet of stud per hour
T 3⅝ 25GA 1¼=Material (track as described)
S 3⅝ 25GA=Material (stud as described)
SHOT AND PIN (MTL)=Material (as described)
MINI SCREW-SHARP PT=Material (as described)
LAYOUT 40 (MTL)=Layout labor production rate of 40 linear feet per hour

All of the material data sets are shared by both automated data sets in the two previous examples because the materials in both examples are identical. However, the labor data sets in the two previous examples are different because the labor requirements are the distinction between the two previous examples.

Referring to FIG. 3b, the first step is to identify the appropriate material data sets. A frequently utilized data set, ⅝″ fire-rated gypsum board, corresponds to the following combination of attributes as described in FIG. 3b:
I.A.1.c. (48″ wide sheet)
I.A.2.d. (⅝″ thick sheet)
I.B.2. (Fire-rated gypsum board)

Another commonly utilized data set, ⅝″ water-resistant gypsum board, similarly corresponds to the following combination of attributes:
I.A.1.c. (48″ wide sheet)
I.A.2.d. (⅝″ thick sheet)
I.B.4. (Water-resistant gypsum board)
   Once again, each distinct material item requires one similarly distinct data set.

The second step is to identify the appropriate labor data sets. A frequently utilized data set, ⅝″ fire-rated gypsum board (floor to deck partition) hanging labor, corresponds to the following combination of attributes as described in the subject outline:
I.A.1.c. (48″ wide sheet)
I.A.2.d. (⅝″ thick sheet)
I.B.2. (Fire-rated gypsum board)
V.A.3. (Hang wallboard on soffit/fascia)

Another commonly utilized data set, ⅝″ fire-rated gypsum board soffit/fascia hanging labor, similarly corresponds to the following combination of attributes:
I.A.1.c. (48″ wide sheet)
I.A.2.d. (⅝″ thick sheet)
I.B.2. (Fire-rated gypsum board)
V.A.3. (Hang wallboard on soffit/fascia)
   Once again, each distinct labor item requires one similarly distinct data set.

The third step is to logically organize the minutiae within each of the data sets. Once again, the familiar data set, ⅝″ fire-rated gypsum board, corresponds to the following combination of attributes as described in the subject outline:
I.A.1.c. (48″ wide sheet)
I.A.2.d. (⅝″ thick sheet)
I.B.2. (Fire-rated gypsum board)

Another commonly utilized data set, ½″ fire-rated gypsum board, similarly corresponds to the following combination of attributes:
I.A.1.c. (48″ wide sheet)
I.A.2.c. (½″ thick sheet)
I.B.2. (Fire-rated gypsum board)

Hence, the only informational variation contained in the multi-tabbed data entry records for these two data sets relates to the thickness of the sheet, because the thickness of the sheet is the only distinguishing characteristic between the two data sets. Likewise, the “⅝” in the former data set and the “½” in the latter data set are the only distinguishing characters in the data sets' names, or codes. The following are the respective codes for the two aforementioned data sets:
⅝″ FC
½″ FC
   The codes name the data sets clearly and precisely.

The fourth and final step to organize the database is to connect the data sets into logical patterns facilitating automation for the end-user. A frequently utilized automated data set, hanging and taping material and labor for ⅝″ fire-rated gypsum board on a ceiling-height 25-gauge stud partition, corresponds to the following combination of attributes as described in FIG. 3b:
I.A.1.c. (48″ wide sheet)
I.A.2.d. (⅝″ thick sheet)
I.B.2. (Fire-rated gypsum board)
III.A.2. (1¼″ fastener length)
III.B.1.a. (Type S Screw)
V.A.2.a. (Hang wallboard on wall from floor to ceiling-height)
IV. (Taping and finishing materials)
V.C.1.b. (Taping and finishing wall labor)

The following data sets would be appropriate to represent this (hanging and taping material and labor for ⅝″ fire-rated gypsum board on a ceiling-height 25-gauge stud partition) assembly:
Material: ⅝″ fire-rated gypsum board
Material: 1¼″ type S Screw
Labor: Hang wallboard to ceiling-height
Material: Taping and finishing materials
Labor: Taping and finishing wall labor

The automated data set for this (hanging and taping material and labor for ⅝″ fire-rated gypsum board on a ceiling-height 25-gauge stud partition) assembly should be distinguishable from other similar data sets. However, three of the five data sets for this assembly are common to other automated data sets. Therefore, the logical selection for this automated data set is the first distinct data set listed above, the labor for hanging wallboard to ceiling-height. Some software systems (designed specifically for construction estimating) limit codes for naming data sets to a relatively small number of characters. Therefore, the present method and system uses the following code to name this (hanging and taping material and labor for ⅝″ fire-rated gypsum board on a ceiling-height 25-gauge stud partition) automated data set:
H ⅝FC150-25 CHP
This code is decoded as follows:
H =Hanging material and labor
⅝FC=⅝″ fire-rated gypsum board
150=Labor production rate of 150 square feet of wallboard per hour
25=25 gauge (this distinction establishes the type of screw in the assembly)
CHP=Ceiling height partition

Thus (refer to FIG. 2a), when the following condition is appropriate:
Hanging and taping material and labor for ⅝″ fire-rated gypsum board on a ceiling-height 25-gauge stud partition

The following automated data set is selected:
H ⅝FC 150-25 CHP

Then, the following data sets will appear automatically:
H ⅝FC 150-25 CHP
1¼″ DRYWALL SCREW
⅝″ FC
TAPING SUPPLIES
FINISH TAPE-175

These codes are decoded as follows:
H ⅝FC 150-25 CHP=Hanging and taping material and labor for ⅝″ fire-rated gypsum board on a ceiling-height 25-gauge stud partition with hanging labor production rate of 150 square feet of wallboard per hour
1¼″ DRYWALL SCREW=Material (as described)
⅝″ FC=Material (as described)
TAPING SUPPLIES=Material (as described)
FINISH TAPE-175=Finish taping labor with production rate of 175 square feet of wall per hour

Another common automated data set is hanging and taping material and labor for ⅝″ fire-rated gypsum board on a 25-guage stud soffit/fascia. Similarly to the previous example, when the following condition is appropriate:
Hanging and taping material and labor for ⅝″ fire-rated gypsum board on a 25-gauge stud soffit/fascia

The following automated data set is selected:
H ⅝FC 78-25 SOFFIT

Then, the following data sets will appear automatically:
H ⅝FC 78-25 SOFFIT
1¼″ DRYWALL SCREW
⅝″ FC
TAPING SUPPLIES
FINISH TAPE-112
These codes are decoded as follows:
H ⅝FC 78-25 SOFFIT=Hanging and taping material and labor for ⅝″ fire-rated gypsum board on a 25-gauge stud soffit/fascia with hanging labor production rate of 78 square feet of wallboard per hour
1¼″ DRYWALL SCREW=Material (as described)
⅝″ FC=Material (as described)
TAPING SUPPLIES=Material (as described)
FINISH TAPE-112=Finish taping labor with production rate of 112 square feet of wall per hour

All of the material data sets are shared by both automated data sets in the two previous examples because the materials in both examples are identical. However, the labor data sets in the two previous examples are different because the labor requirements are the distinction between the two previous examples.

Referring to FIG. 3c, the first step is to identify the appropriate material data sets. A frequently utilized data set, 3½″×6″ sound attenuating batt insulation, corresponds to the following combination of attributes as described in FIG. 3c:
I.A.1.a. (16″ width)
I.A.2.h. (3½″ thickness)
I.B.3. (Fiberglass batt)
I.C.1. (Unfaced)
I.D.1. (Sound attenuation)

Another commonly utilized data set, 3½×16″ flame spread 25 foil-reinforced kraft-faced batt insulation, similarly corresponds to the following combination of attributes:
I.A.1.a. (16″ width)
I.A.2.h. (3½″ thickness)
I.B.3. (Fiberglass batt)
I.C.4. (Flame spread 25 foil-reinforced kraft faced)
I.D.2. (Thermal resistance)
I.D.3. (Water vapor barrier)
   Once again, each distinct material item requires one similarly distinct data set.

The second step is to identify the appropriate labor data sets. A frequently utilized data set, 3½″×16″ sound attenuating batt insulation friction-fit application labor, corresponds to the following combination of attributes as described in FIG. 3c:
I.A.1.a. (16″ width)
I.A.2.h. (3½″ thickness)
I.B.3. (Fiberglass batt)
I.C.1. (Unfaced)
I.D.1. (Sound attenuation)
IV.A.1. (Friction-fit application)

Another commonly utilized data set, 3½″×16″ flame spread 25 foil-reinforced kraft-faced batt insulation impale and clip application with foil-taped joints labor, similarly corresponds to the following combination of attributes:
I.A.1.a. (16″ width)
I.A.2.h. (3½″ thickness)
I.B.3. (Fiberglass batt)
I.C.4. (Flame spread 25 foil-reinforced kraft faced)
I.D.2. (Thermal resistance)
I.D.3. (Water vapor barrier)
II.C. (Foil tape)
III.A. (Impaling pin and clip washer)
IV.A.2. (Impale and clip application)
IV.B.3. (Foil tape application)
V.B.4. (Impaling pin application)
   Once again, each distinct labor item requires one similarly distinct data set.

The third step is to logically organize the minutiae within each of the data sets. Once again, the familiar data set, 3½″×16″ sound attenuating batt insulation, corresponds to the following combination of attributes as described in FIG. 3c:
I.A.1.a. (16″ width)
I.A.2.h. (3 1/22″ thickness)
I.B.3. (Fiberglass batt)
I.C.1. (Unfaced)
I.D.1. (Sound attenuation)

Another commonly utilized data set, 2½″×16″ sound attenuating batt insulation, similarly corresponds to the following combination of attributes:
I.A.1.a. (16″ width)
I.A.2.f. (2½″ thickness)
I.B.3 . (Fiberglass batt)
I.C.1. (Unfaced)
I.D.1. (Sound attenuation)

Hence, the only informational variation contained in the multi-tabbed data entry records for these two data sets relates to the thickness, because the thickness is the only distinguishing characteristic between the two data sets. Likewise, the “3” in the former data set and the “2” in the latter data set are the only distinguishing characters in the data sets' names, or codes. The following are the respective codes for the two aforementioned data sets:
3½″ UF FG S-BATT
2½″ UF FG S-BATT

The codes name the data sets clearly and precisely. The width is not indicated in the code because the width can be altered via minutiae within each of the data sets.

The fourth and final step to organize the database is to connect the data sets into logical patterns facilitating automation for the end-user. A frequently utilized automated data set, material and labor for 3½″×16″ sound attenuating batt insulation friction-fit application, corresponds to the following combination of attributes as described in FIG. 3c.
I.A.1.a. (16″ width)
I.A.2.h. (3½″ thickness)
I.B.3. (Fiberglass batt)
I.C.1. (Unfaced)
I.D.1. (Sound attenuation)
IV.A.1. (Friction-fit application)

The following data sets would be appropriate to represent this (material and labor for 3½″×16″ sound attenuating batt insulation friction-fit application) assembly:

Material: 3½″ unfaced fiberglass sound batt insulation
Labor: Insulate wall—3½″ unfaced fiberglass batt—friction-fit application in wall/partition

The automated data set for this (material and labor for 3½″×16″ sound attenuating batt insulation friction-fit application in wall/partition) assembly should be distinguishable from other similar data sets. However, the material data set for this assembly is common to other automated data sets. Therefore, the logical selection for this automated data set is the only distinct data set listed above, the labor data set. Some software systems (designed specifically for construction estimating) limit codes for naming data sets to a relatively small number of characters. Therefore, the present method and system uses the following code to name this (material and labor for 3½″×16″ sound attenuating batt insulation friction-fit application in wall/partition) automated data set:
I 3UFSB 200 WALL FF
This code is decoded as follows:
I=Insulate
3UFSB=3½″ unfaced fiberglass sound attenuating batt
200=Labor production rate of 200 square feet of insulation per hour
WALL=Wall/partition application location
FF=Friction-fit application

Thus (refer to FIG. 2a), when the following condition is appropriate:
Material and labor for 3½″×16″ sound attenuating batt insulation friction-fit application in wall/partition

The following automated data set is selected:

I 3UFSB 200 WALL FF

Then, the following data sets will appear automatically:
I 3UFSB 200 WALL FF
3½″ UF FG S-BATT

These codes are decoded as follows:
I 3UFSB 200 WALL FF=Material and labor for 3½″×16″ sound attenuating batt insulation, friction-fit application in wall/partition with labor production rate of 200 square feet of insulation per hour
3½″ UF FG S-BATT=3½″ unfaced fiberglass sound batt insulation

Another common automated data set is material and labor for 3½″×16″ sound attenuating batt insulation friction-fit application in soffit/fascia. Similarly to the previous example, when the following condition is appropriate:
Material and labor for 3½″×16″ sound attenuating batt insulation friction-fit application in soffit/fascia

The following automated data set is selected:
I 3UFSB 150 SOFF FF

Then, the following data sets will appear automatically:
I 3UFSB 150 SOFF FF
3½″ UF FG S-BATT

These codes are decoded as follows:
I 3UFSB 150 SOFF FF=Material and labor for 3½″×16″ sound attenuating batt insulation friction-fit application in soffit/fascia with labor production rate of 150 square feet of insulation per hour
3½″ UF FG S-BATT=3½″ unfaced fiberglass sound batt insulation

The material data sets are shared by both automated data sets in the two previous examples because the materials in both examples are identical. However, the labor data sets in the two previous examples are different because the labor requirements are the distinction between the two previous examples.

Referring to FIGS. 3d and 3e, the following is clarification of the phrase, “within the limitation of reasonable parameters” (with reference to material, labor, and automated data sets). The present method and system includes a distinct data set representing each distinct labor item and generic material item (within the limitation of reasonable parameters). However, specialized data sets for specific paint colors are categorized rather than segregated for the following four reasons:
(1) The material pricing aspect within each selected paint color category does not vary. Likewise, the labor aspect within each selected paint color category does not vary.
(2) The addition of distinct material data sets identifying these relatively redundant specific paint colors attributes would clutter the database and add confusion for the end user. Furthermore, the additional material data sets would require correlated automated data sets; this would also clutter the database and add confusion for the end user. Inevitably, the added clutter and confusion would be counterproductive.
(3) The present method and system's database assimilates suspension system assemblies via a distinct automated data set for each (within the limitation of industry-standard material production) combination of (refer to FIG. 3d) fire rating (I.B.), system function (I.C.), metal thickness (II.C.), face width (II.D.3.), material type (II.E.), and paint finish (II.F.1.).
(4) The database associated with the present method and system assimilates acoustic ceiling tile system assemblies via a distinct automated data set for each (within the limitation of industry-standard material production) combination of (refer to FIG. 3e) fire rating (I.B.), system function (I.E.), dimensional properties (II.), material composition (III.), access components (IV.), and miscellaneous clips, etc. (V.).

At first perception, a single distinct automated labor data set representing each of the above combinations of attributes might seem to be overly simplistic. After all, actual labor production rates for ceiling suspension systems and acoustic ceiling tile systems vary significantly. However, these significant rate variations within each distinct type of ceiling system are fundamentally bound to one simple ratio, the ratio of area to perimeter. Therefore, only data sets related to area are calculated relative to area quantities; data sets related to perimeter are calculated relative to perimeter quantities. The logical organization of the minutiae within each of the data sets incorporates default settings for these calculations.

Nevertheless, occasionally data sets other than the default selections are appropriate; the end user can accommodate this situation as follows:
After selecting the most closely related automated data set to the appropriate assembly, the end user can then substitute or add the appropriate labor and/or material data sets, thereby refining the assembly to the exact requirements of any given architectural detail or condition.

Referring to FIG. 3d, the first step is to identify the appropriate material data sets. A frequently utilized data set, 15/16″×1½″×12′, 0.015″ double web standard white Class “A” main runner, corresponds to the following combination of attributes as described in FIG. 3d:
I.B.1. (Class “A” non-combustible)
II.B.1.a. (Main tee)
II.C.1.b. (0.015)
II.D.1.b. (12′ length)
II.D.2.b. (1½″ web height)
II.D.3.b. ( 15/16″ face width)
II.E.1. (Galvanized steel)
II.F.1.a. (Standard white)

Another commonly utilized data set, 15/16″×1½″×4′, 0.015″ double web standard white Class “A” cross tee, similarly corresponds to the following combination of attributes:
I.B.1. (Class “A” non-combustible)
II.B.2.a. (Standard locking cross tee)
II.C.1.b. (0.015)
II.D.1.e. (4′ length)
II.D.2.b. (1½″ web height)
II.D.3.b. ( 15/16″ face width)
II.E.1. (Galvanized steel)
II.F.1.a. (Standard white)
   Once again, each distinct material item requires one similarly distinct data set.

The second step is to identify the appropriate labor data sets. A frequently utilized data set, 12-gauge hanger wire labor, corresponds to the following combination of attributes as described in FIG. 3d:
IV.A.1.a. (12 gauge hanger wire labor)

Another commonly utilized data set, 9-gauge hanger wire labor, similarly corresponds to the following combination of attributes:
IV.A.1.b. (9 gauge hanger wire labor)
   Once again, each distinct labor item requires one similarly distinct data set.

The third step is to logically organize the minutiae within each of the data sets. Once again, the familiar data set, 15/16″×1½″×12′, 0.015″ double web standard white Class “A” main runner, corresponds to the following combination of attributes as described in FIG. 3d:
I.B.1. (Class “A” non-combustible)
II.B.1.a. (Main tee)
II.C.1.b. (0.015)
II.D.1.b. (12′ length)
II.D.2.b. (1½″ web height)
II.D.3.b. ( 15/16″ face width)
II.E.1. (Galvanized steel)
II.F.1.a. (Standard white)

Another commonly utilized data set, 15/16″×1½″×12′, 0.015″ double web standard white fire-rated main runner, corresponds to the following combination of attributes as described in FIG. 3d:
I.B.2. (Fire-rated for dimensional stability)
II.B.1.a. (Main tee)
II.C.1.b. (0.015)
II.D.1.b. (12′ length)
II.D.2.b. (1½″ web height)
II.D.3.b. ( 15/16″ face width)
II.E.1. (Galvanized steel)
II.F.1.a. (Standard white)

Hence, the only informational variation contained in the multi-tabbed data entry records for these two data sets relates to the fire rating, because the fire rating is the only distinguishing characteristic between the two data sets. Likewise, the “A” in the former data set and the “F” in the latter data set are the only distinguishing characters in the data sets' names, or codes. The following are the respective codes for the two aforementioned data sets:
15/16STD.015AWMAIN
15/16STD.015FWMAIN

The codes name the data sets clearly and precisely. The former code is decoded as follows:
15/16= 15/16″ face width
STD=Standard 1½″ web height
0.015=0.015 metal thickness
A=Class “A” non-combustible
W=Standard white
MAIN=Double web main runner

The latter code is decoded as follows:
15/16= 15/16″ face width
STD=Standard 1½″ web height
0.015=0.015 metal thickness
F=Fire-rated
W=Standard white
MAIN=Double web main runner

The fourth and final step appropriate to organize the database is to connect the data sets into logical patterns facilitating automation for the end-user. A frequently utilized automated data set, 2′×4′ grid material and labor for a 15/16″×1½″, 0.015″ double web standard white Class “A” suspension system, corresponds to the following combination of attributes as described in FIG. 3d:
I.B.1. (Class “A” non-combustible)
I.C.1.b. (Suspension system for 24″×48″ ceiling panels)
II.A.1.a. (12 gauge hanger wire)
II.A.2.a. (Galvanized hanger wire)
II.B.1.a. (Main tee)
II.B.2.a. (Cross tee)
II.C.1.b. (0.015)
II.D.1.b. (12′ length)
II.D.1.e. (4′ length)
II.D.2.b. (1½″ web height)
II.D.3.b. ( 15/16″ face width)
II.E.1. (Galvanized steel)
II.F.1.a. (Standard white)
III.H. Fence staples (This example is based on gypsum board walls and bar joist ceiling structure.)
IV.A.1. (12 gauge hanger wire labor)
IV.A.2. (2′×4′, 15/16″×1½″, 0.015″ double web standard white Class “A” grid system labor)
IV.B. (Wall molding labor)

The following data sets represent this (2′×4′ grid material and labor for a 15/16″×1½″, 0.015″ double web standard white Class “A” suspension system) assembly:
Material: 12 gauge hanger wire
Labor: 12 gauge hanger wire
Material: 15/16″×1½″×12 ′ 0.015″ double web standard white Class “A” main runner
Material: 15/16″×1½″×4′ 0.015″ double web standard white Class “A” cross tee
Material: 15/16″×1½″×2′ 0.015″ double web standard white Class “A” cross tee
Material: 15/16″×1½″×2′ 0.015″ double web standard white Class “A” cross tee
Labor: 2′×4′, 15/16″×1½″, 0.015″ double web standard white Class “A” grid system
Material: Angle (“L” shaped) wall molding
Material: Fence staples
Labor: Angle (“L” shaped) wall molding
Material: Pop rivets
Labor: Cut suspension system components at wall angle

The automated data set for this (2′×4′ grid material and labor for a 15/16″×1½″, 0.015″ double web standard white Class “A” suspension system) assembly should be distinguishable from other similar data sets. However, nine of the ten data sets appropriate for this assembly are common to other automated data sets. Therefore, the logical selection for this automated data set is the only distinct data set listed above, the labor for a 2′×4′, 15/16″×1½″, 0.015″ double web standard white Class “A” grid system. Some software systems (designed specifically for construction estimating) limit codes for naming data sets to a relatively small number of characters. Therefore, the present method and system uses the following code to name this (2′×4′ grid material and labor for a 15/16″×1½″, 0.015″ double web standard white Class “A” suspension system) automated data set:
G2×415STD.015AW375

This code is decoded as follows:
G=Grid system material and labor
2×4=2′×4′
15= 15/16″ face width
STD=Standard 1½″ web height
0.015=0.015 metal thickness
A=Class “A” non-combustible
W=Standard white
375=Grid labor production rate of 375 square feet of grid per hour

Thus (refer to FIG. 2b), when the following condition is appropriate:
2′×4′ grid material and labor for a 15/16″×1½″, 0.015″ double web standard white Class “A” suspension system

The following automated data set is selected:
G2×415STD.015AW375

Then, the following data sets will appear automatically:
G2×415STD.015AW375
GRID CUTS-2×4
ANGLE MLDG LABOR
HANGER-12GA-48LABOR
HANGER-12GA-48×″48″OC
15/16STD.015AWMAIN
15/16STD.015AW4′TEE
15/16STD.015AW2′TEE
15/16SQ.024SEWANGLEM
POP RIV (2×4)
FENCE STAPLE
HARD CASE NAIL
FLEX ANGLE LABOR
FLEX ANGLE

These codes are decoded as follows:
G2×415STD.015AW375=2′×4′ grid material and labor for a 15/16″×1½″, 0.015″ double web standard white Class “A” suspension system with grid labor production rate of 375 square feet of grid per hour
GRID CUTS-2×4=Labor related to cutting grid members at perimeter of 2′×4′ grid suspension system
ANGLE MLDG LABOR=Labor related to application of angle molding at perimeter of grid suspension system
HANGER-12GA-48LABOR=Labor related to application of 12 gauge hanger wires at 48″×48″ on center
HANGER-12GA-48″×48″OC=Material related to application of 12 gauge hanger wires at 48″×48″ on center
15/16STD.015AWMAIN=Material: 15/16″×1½″×12′0.015″ double web standard white Class “A” main runner
15/16STD.015AW4′TEE=Material: 15/16″×1½″×4′0.015″ double web standard white Class “A” cross tee
15/16STD.015AW2′TEE=Material: 15/16″×1½″×2′0.015″ double web standard white Class “A” cross tee
15/16SQ.024SEWANGLEM=Material: 15/16″× 15/16″0.024″ straight edge standard white wall angle
POP RIV (2×4)=Material related to application of pop rivets in a 2′×4″ grid suspension system
FENCE STAPLE=Material (as described)
HARD CASE NAIL=Material (as described)
FLEX ANGLE LABOR=Labor related to application of flexible angle molding at perimeter of grid suspension system
FLEX ANGLE MOLDING=Material (as described)

Another common automated data set is 2′×4′ grid material and labor for a 15/16″×1½″, 0.015″ double web standard white fire-rated suspension system. Similarly to the previous example, when the following condition is appropriate:
2′×4′ grid material and labor for a 15/16″×1½″, 0.015″ double web standard white fire-rated suspension system

The following automated data set is selected:
G2×415STD.015FW375

Then, the following data sets will appear automatically:
G2×415STD.015FW375
GRID CUTS-2×4
ANGLE MLDG LABOR
HANGER-12GA-48LABOR
HANGER-12GA-48″×48″OC
15/16STD.015FWMAIN
15/16STD.015FW4′TEE
15/16STD.015FW2′TEE
15/16SQ.024SEWANGLEM
POP RIV (2×4)
FENCE STAPLE
HARD CASE NAIL
FLEX ANGLE LABOR
FLEX ANGLE

These codes are decoded as follows:
G2×415STD.015FW375=2′×4′ grid material and labor for a 15/16″×1½″, 0.015″ double web standard white fire-rated suspension system with grid labor production rate of 375 square feet of grid per hour
GRID CUTS-2×4=Labor related to cutting grid members at perimeter of 2′×4′ grid suspension system
ANGLE MLDG LABOR=Labor related to application of angle molding at perimeter of grid suspension system
HANGER-12GA-48LABOR=Labor related to application of 12 gauge hanger wires at 48″×48″ on center
HANGER-12GA-48″×48″OC=Material related to application of 12 gauge hanger wires at 48″×48″ on center
15/16STD.015FWMAIN=Material: 15/16″×1½″×12′0.015″ double web standard white fire-rated main runner
15/16STD.015FW4′TEE=Material: 15/16″×1½″×4′, 0.015″ double web standard white fire-rated cross tee
15/16STD.015FW2′TEE=Material: 15/16″×1½−×2′, 0.015″ double web standard white fire-rated cross tee
15/16SQ.024SEWANGLEM=Material: 15/16″× 15/16″0.024″ straight edge standard white wall angle
POP RIV (2×4)=Material related to application of pop rivets in a 2′×4′ grid suspension system
FENCE STAPLE=Material (as described)
HARD CASE NAIL=Material (as described)
FLEX ANGLE LABOR=Labor related to application of flexible angle molding at perimeter of grid suspension system
FLEX ANGLE MOLDING=Material (as described)

In the two previous examples, the two automated data sets share the ten data sets that are unrelated to the fire rating; therefore, these ten data sets, unrelated to the fire rating, are identical in each example. However, four data sets (including the automated data set), in each of the two previous examples, are related to the fire rating; these eight (four in each example) data sets represent the only distinctions among the data in the two previous examples.

Referring to FIG. 3e, the first step is to identify the appropriate material data sets. A frequently utilized data set, 24″×48″×⅝″ square edge wet-felted mineral fiber standard white Class “A” panel, corresponds to the following combination of attributes as described in FIG. 3e:
I.B.1. (Class “A” non-combustible)
I.E.3. (Lay-in panel)
II.A.3. (24″×48″ nominal face dimensions)
II.B.2. (⅝″ thickness)
II.C.1. (Square edge)
III.A.1.a. (Mineral core water-felted composition)
III.B.1. (Painted face)
III.E.1. (Standard white)

Another commonly utilized data set, 24″×24″×⅝″ reveal edge ( 15/16″ grid) wet-felted mineral fiber standard white Class “A” panel, similarly corresponds to the following combination of attributes:
I.B.1. (Class “A” non-combustible)
I.E.3. (Lay-in panel)
II.A.2. (24″×24″ nominal face dimensions)
II.B.2. (⅝″ thickness)
II.C.2. (Reveal edge)
III.A.1.a. (Mineral core water-felted composition)
III.B.1. (Painted face)
III.E.1. (Standard white)
   Once again, each distinct material item requires one similarly distinct data set.

The second step is to identify the labor data sets. A frequently utilized data set, perimeter-cutting labor for square edge wet-felted mineral fiber tile, corresponds to the following combination of attributes as described in FIG. 3e:
VI.B.1.a. (Square edge)
IV.B.2.a. (Mineral core water-felted composition)
IV.B.6.a. (Painted face)

Another commonly utilized data set, perimeter-cutting labor for reveal edge ( 15/16″ grid) wet-felted mineral fiber tile, similarly corresponds to the following combination of attributes:
VI.B.1.b. (Reveal edge)
IV.B.2.a. (Mineral core water-felted composition)
IV.B.6.a. (Painted face)
   Once again, each distinct labor item requires one similarly distinct data set.

The third step is to logically organize the minutiae within each of the data sets. Once again, the familiar data set, 24″×48″×⅝″ square edge wet-felted mineral fiber standard white Class “A” panel, corresponds to the following combination of attributes as described in FIG. 3e:
I.B.1. (Class “A” non-combustible)
I.E.3. (Lay-in panel)
II.A.3. (24″×48″ nominal face dimensions)
II.B.2. (⅝″ thickness)
II.C.1. (Square edge)
III.A.1.a. (Mineral core water-felted composition)
III.B.1. (Painted face)
III.E.1. (Standard white)

Another commonly utilized data set, 24″×48″×⅝″ square edge wet-felted mineral fiber standard white fire-rated panel, corresponds to the following combination of attributes as described in FIG. 3e:
I.B.2. (Fire-rated for dimensional stability)
I.E.3. (Lay-in panel)
II.A.3. (24″×48″ nominal face dimensions)
II.B.2. (⅝″ thickness)
II.C.1. (Square edge)
III.A.1.a. (Mineral core water-felted composition)
III.B.1. (Painted face)
III.E.1. (Standard white)

Hence, the only informational variation contained in the multi-tabbed data entry records for these two data sets relates to the fire rating, because the fire rating is the only distinguishing characteristic between the two data sets. Likewise, the “A” in the former data set and the “F” in the latter data set are the only distinguishing characters in the data sets' names, or codes. The following are the respective codes for the two aforementioned data sets:
2×4SE-⅝MWAPW PANEL
2×4SE-⅝MWFPW PANEL

The codes name the data sets clearly and precisely. The former code is decoded as follows:
2×4=24″×48″ nominal face dimensions
SE=Square edge
⅝=⅝″ thickness
MW=Mineral core water-felted composition
A=Class “A” non-combustible
PW=Paint face membrane standard white
PANEL=Lay-in acoustic ceiling panel
The latter code is decoded as follows:
2×4=24″×48″ nominal face dimensions
SE=Square edge
⅝=⅝″ thickness
MW=Mineral core water-felted composition
F=Fire-rated
PW=Paint face membrane standard white
PANEL=Lay-in acoustic ceiling panel

The fourth and final step to organize the database is to connect the data sets into logical patterns facilitating automation for the end-user. A frequently utilized automated data set, material and labor for a 24″×48″×⅝″ square edge wet-felted mineral fiber standard white Class “A” panel system, corresponds to the following combination of attributes as described in FIG. 3e:
I.B.1. (Class “A” non-combustible)
I.E.3. (Lay-in panel)
II.A.3. (24″×48″ nominal face dimensions)
II.B.2. (⅝″ thickness)
II.C.1. (Square edge)
III.A.1.a. (Mineral core water-felted composition)
III.B.1. (Painted face)
III.E.1. (Standard white)
VI.A.1.b. (24″×48″ lay-in panel)
VI.B.1.a. (Square edge)
VI.B.2.a. (water-felted mineral core)
VI.B.6.a. (Pant face membrane)

The following data sets would represent this (material and labor for a 24″×48″×⅝″ square edge wet-felted mineral fiber standard white Class “A” panel system) assembly:
Material: 24″×48″×⅝″ square edge wet-felted mineral fiber standard white Class “A” panel
Labor: 24″×48″×⅝″ square edge wet-felted mineral fiber standard white Class “A” panel
Labor: Perimeter cut—square edge wet-felted mineral fiber panel

The automated data set for this (material and labor for a 24″×48″×⅝″ square edge wet-felted mineral fiber standard white Class “A” panel system) assembly should be distinguishable from other similar data sets. Of the three data sets appropriate for this assembly, only one is common to other automated data sets. The logical selection for this automated data set is the only distinct labor data set listed above, the labor to lay-in 24″×48″×⅝″ square edge wet-felted mineral fiber standard white Class “A” panels. Some software systems (designed specifically for construction estimating) limit codes for naming data sets to a relatively small number of characters. Therefore, the present method and system uses the following code to name this (material and labor for a 24″×48″×⅝″ square edge wet-felted mineral fiber standard white Class “A” panel system) automated data set:
L24SE-⅝MWAPW 500

This code is decoded as follows:
L=Lay-in panel system material and labor
24=24″×48″
SE-⅝=Square edge−⅝″ thick
MW=Mineral core water-felted composition
A=Class “A” non-combustible
PW=Paint face membrane standard white
500=Lay-in labor production rate of 500 square feet of panels per hour

Thus (refer to FIG. 2b), when the following condition is appropriate:
Material and labor for a 24″×48″×⅝″ square edge wet-felted mineral fiber standard white Class “A” panel system

The following automated data set is selected:
L24SE-⅝MWAPW 500

Then, the following data sets will appear automatically:
L24SE-⅝MWAPW 500
2×4SE-⅝MWAPW PANEL
PERICUT SE-MWP PANEL
RADICUT SE-MWP PANEL

These codes are decoded as follows:
L24SE-⅝MWAPW 500=Material and labor for a 24″×48″×⅝″ square edge wet-felted mineral fiber standard white Class “A” panel system with lay-in labor production rate of 500 square feet of panels per hour
2×4SE-⅝MWAPW PANEL=Material for a 24″×48″×⅝″ square edge wet-felted mineral fiber standard white Class “A” panel system
PERICUT SE-MWP PANEL=Labor related to cutting square edge wet-felted mineral fiber panels at perimeter
RADICUT SE-MWP PANEL=Labor related to cutting square edge wet-felted mineral fiber panels on radius at perimeter

Another common automated data set is material and labor for a 24″×48″×⅝″ square edge wet-felted mineral fiber standard white fire-rated panel system. Similarly to the previous example, when the following condition is appropriate:
material and labor for a 24″×48″×⅝″ square edge wet-felted mineral fiber standard white fire-rated panel system

The following automated data set is selected:
L24SE-⅝MWFPW 500

Then, the following data sets will appear automatically:
L24SE-⅝MWFPW 500
2×4SE-⅝MWFPW PANEL
PERICUT SE-MWP PANEL
RADICUT SE-MWP PANEL

These codes are decoded as follows:
L24SE-⅝MWFPW 500=Material and labor for a 24″×48″×⅝″ square edge wet-felted mineral fiber standard white fire-rated panel system with lay-in labor production rate of 500 square feet of panels per hour
2×4SE-⅝MWFPW PANEL=Material for a 24″×48″×⅝″ square edge wet-felted mineral fiber standard white fire-rated panel system
PERICUT SE-MWP PANEL=Labor related to cutting square edge wet-felted mineral fiber panels at perimeter
RADICUT SE-MWP PANEL=Labor related to cutting square edge wet-felted mineral fiber panels on radius at perimeter

In the two previous examples, the two automated data sets share the two data sets that are unrelated to the fire rating; therefore, these two data sets, unrelated to the fire rating, are identical in each example. However, the other two data sets (including the automated data set), in each of the two previous examples, are related to the fire rating; these four (two in each example) data sets represent the only distinctions among the data in the two previous examples.

Although the present method and system are designed specifically for building construction estimating, they also adaptable to project estimating generally, including, for example, road, bridge and tunnel construction estimating, and manufacturing and product assembly process estimating. Furthermore, the term “building construction” refers generally to the erection of enclosed structures, including, for example, residential, commercial and industrial structures.

The present method and system overcome inefficiencies and inadequacies associated with traditional construction estimating databases available in software designed specifically for construction estimating. Two primary concepts, divergent from conventional techniques regarding the organization of these databases, underlie the present method and system. These two concepts are “end user logic” and “fully comprehensive scope”.

The first primary concept, “end user logic”, logically separates data sets into the following three categories:
(1) Material data sets.
(2) Labor data sets.
(3) Automated data sets.
   This fundamental modification enables the end user to manage a database that is comprehensive in scope.

The second major concept, “fully comprehensive scope”, is simply a complete database inclusive of the data sets desired by professional construction estimators of the aforementioned trades. A comprehensive database includes the following three components:
(1) Data sets representing standard materials currently produced in the industry.
(2) Data sets representing aspects of labor associated with the industry.
(3) Automated data sets representing logical combinations of standard materials and labor aspects for assemblies utilized in the industry.

By compiling complete and accurate data, and organizing a database correctly, the present system and method can facilitate both speed and accuracy during the process of construction takeoffs and estimates for professional estimators. Additionally, this process becomes less demanding on the intellect of the end user (estimator), because much of the judgment has been replaced by automation within the database itself.

Consequently, construction business owners can now afford the opportunity to allow less experienced estimators to produce much more “experienced” results; additionally, construction business owners can more fully utilize the expertise of experienced estimators. Nevertheless, the process is equally well-suited to even experienced estimators. The time saved by the experienced estimator can be used to refine both his/her estimates and/or the estimates produced by less experienced colleagues.

Moreover, time saved by estimators within a company allows that company's executive administrators to reallocate estimating tasks for the following reasons:

Benefits to inexperienced estimators

Inexperienced estimators can learn more because the automation associated with the present method and apparatus provides them with access to insightful information.

Inexperienced estimators can produce more work because the automation associated with the present method and system reduces uncertainty associated with the processes.

Inexperienced estimators can perform more advanced tasks because the automation associated with the present method and system provides them with more accurate results.

Benefits to experienced estimators

Experienced estimators can be more productive because the automation associated with the present method and system reduces stress and fatigue associated with the thought processes.

Experienced estimators can produce better work because automation associated with the present method and system allows them the luxury of extra time to review and refine their work.

Experienced estimators can supervise their colleagues, who are not as knowledgeable, more effectively because the automation associated with the present method and system promotes uniformity and consistency in estimates produced by the entire estimating staff.

Furthermore, timesaving does not end in the estimating department; rather, this is just the beginning. Now the company's executive administrators have more flexibility to reallocate tasks related to project management for the following reasons:
The less experienced employees can communicate their ideas more effectively because the consistency of the present method and system helps co-workers to act in concert more quickly and thoroughly.
The more experienced employees can utilize time saved via the automation associated with the present method and system by becoming advocates of synergy among the company's estimating, accounting, and construction departments. The more experienced employees can redistribute their expertise to augment efficiency within and among each of the company's departments.

An important benefit also associated with the present method and system is removing the drudgery associated with estimating, thereby encouraging workers using the present method and system to become more productive members of their companies.

While particular elements, embodiments and applications of the present invention have been shown and described, it will be understood, of course, that the invention is not limited thereto since modifications may be made by those skilled in the art without departing from the scope of the present disclosure, particularly in light of the foregoing teachings.

1. A method for construction estimating to facilitate the estimation of construction activities including at least one of metal stud framing, wallboard construction, ceiling suspension, acoustical ceiling tile construction and related insulation systems, the method comprising the steps of:
(a) compiling construction activity data in a database;
(b) categorizing the data in the database according to construction related parameters;
(c) employing a database analysis and reporting system to construction estimating.

2. The method of claim 1 wherein the data includes area and perimeter measurements such that ratios can be employed to calculate labor production rates.

3. The method of claim 1 wherein the data is organized such that each of the data sets contains at least one of construction material data and construction labor data.

4. The method of claim 3 wherein each of the data sets contains construction labor data organized such that each of the labor data sets represents at least one of labor alone and labor with automation.

5. The method of claim 4 wherein each of the data sets contains construction labor data organized such that each of the labor data sets represents labor with automation and each of the labor-with-automation data sets links other related data sets to form logical assemblies.

6. The method of claim 1 wherein the data sets are categorized into the three categories of construction material, construction labor and construction labor-with-automation.

7. A construction estimating system for facilitating the estimation of construction activities including at least one of metal stud framing, wallboard construction, ceiling suspension, acoustical ceiling tile construction and related insulation systems, the system comprising:
(a) a database comprising construction activity data;
(b) a routine for categorizing the data in the database according to construction related parameters;
(c) a database analysis and reporting function.

8. The system of claim 7 wherein the data includes area and perimeter measurements for calculating ratios employable to calculate labor production rates.

9. The system of claim 7 wherein the data comprises data sets comprising at least one of construction material data and construction labor data.

10. The method of claim 9 wherein each of the data sets contains construction labor data organized such that each of the labor data sets represents at least one of labor alone and labor with automation.

11. The system of claim 10 wherein each of the data sets contains construction labor data organized such that each of the labor data sets represents labor with automation and each of the labor-with-automation data sets links other related data sets to form logical assemblies.

12. The system of claim 7 wherein the data sets are categorized into the three categories of construction material, construction labor and construction labor-with-automation.
